(19) United States
(12) Patent Application Publication
(10) Pub. No.: US 2023/0069461 A1
(43) Pub. Date: Mar. 2, 2023

(54) IN-VEHICLE CONTROL SYSTEM AND ABNORMALITY DIAGNOSIS METHOD

(71) Applicant: Mitsubishi Electric Corporation, Tokyo (JP)

(72) Inventor: Hiroshi OKUYAMA, Tokyo (JP)

(73) Assignee: Mitsubishi Electric Corporation, Tokyo (JP)

(21) Appl. No.: 17/796,331

(22) PCT Filed: Apr. 10, 2020
(86) PCT No.: PCT/JP2020/016141

§ 371 Date: Jul. 29, 2022

(51) Int. Cl. G06F 21/57; B60W 50/02

(52) U.S. Cl. CPC G06F 21/57; B60W 50/0205; B60W 2050/021

(57) ABSTRACT

The in-vehicle control system in which a plurality of ECUs for controlling in-vehicle devices are connected to be able to communicate with each other is provided with an information set setting unit for setting an information set by combining information targeting different ECUs from among the original information relating to control functions of sound ECUs, an information collecting unit for collecting present information corresponding to the original information from each of the ECUs targeted by the information set, and an abnormality detection unit for detecting any one of the ECUs targeted to be abnormal when a degree of coincidence between correct answer information calculated by an evaluation function f with the information set as an argument and an evaluation value calculated by the evaluation function with the present information corresponding to the information set as an argument is lower than a criterion.

### TECHNICAL FIELD

The present application relates to an in-vehicle control system and an abnormality diagnosis method.

### BACKGROUND ART

An in-vehicle control device called an electronic control unit (ECU) is installed in a plural number in a vehicle, and the control device is connected to another ECU or a communication device outside the vehicle by wire or wireless. Thus, by controlling in-vehicle devices independently or in cooperation, basic functions related to the running of a vehicle such as running, turning, and stopping, functions for controlling the environment inside the vehicle, and functions for providing information such as navigation are implemented.

Meanwhile, a malicious person may carry out a security attack such that incorrect information is loaded in an ECU, and this security attack may cause an abnormal operation in an in-vehicle device. In response to the above, a technology is disclosed in which an unauthorized new service can be prevented from being plugged in by determining whether or not to provide a new service according to a test result that has been performed before starting to provide the new service for example, refer to Patent Document 1).

### CITATION LIST

### Patent Document

Patent Document 1: Japanese Unexamined Patent Application Publication No. 2016-163244 (Paragraphs 0039 to 0083, FIG. 7 to FIG. 9)

### SUMMARY OF INVENTION

### Problems to be Solved by Invention

However, the disclosed technology targets the authentication of services added by the addition of an ECU or a function change to an ECU. Therefore, it is not intended to respond to attacks that cannot be prevented by the authentication of services alone, such as an attack that tampers with the platform used to run services, or an attack that allows unauthorized services to be run through an abuse of the services. Of course, it is conceivable to perform secure boot of each ECU, but it is necessary to store an encryption key for the secure boot, and at the same time, there is a possibility that the activation time increases and the vehicle control is rather disturbed.

The present application discloses a technique for solving the above-described problems, and an object thereof is to enable a vehicle control to be executed soundly even when a security attack related to the vehicle control is received.

### Means for Solving Problems

An in-vehicle control system disclosed in the present application in which a plurality of control devices controlling in-vehicle devices are connected to be able to communicate with each other includes an original information storage unit to store original information related to either a program to implement a control function or operation specifications in the control function when each of the plurality of control devices is sound, an information set setting unit to set information set to be used as an argument of a function by combining information targeting different control devices from among the original information, an information collecting unit to collect present information corresponding to the original information as present information from each of the control devices targeted in the information set, and an abnormality detection unit to detect any one of the targeted control devices to be abnormal when a degree of coincidence between a correct answer value calculated by the function with the information set as an argument and an evaluation value calculated by the function with the present information corresponding to the information set as an argument is lower than a criterion.

The abnormality diagnosis method disclosed in the present application is a method for diagnosing an abnormality in an in-vehicle control system in which a plurality of control devices controlling in-vehicle devices are connected to be able to communicate with each other, and includes an original information storage step of storing original information related to either a program to implement a control function or operation specifications in the control function when each of the plurality of control devices is sound, an information set setting step of setting information set to be used as an argument of a function by combining information targeting different control devices from among the original information, an information collecting step of collecting present information corresponding to the original information as present information from each of the control devices targeted in the information set, and an abnormality detection step of detecting any one of the targeted control devices to be abnormal when a degree of coincidence between a correct answer value calculated by the function with the information set as an argument and an evaluation value calculated by the function with the present information corresponding to the information set as an argument is lower than a criterion.

### Effect of Invention

According to the in-vehicle control system or the abnormality diagnosis method disclosed in the present application, since the soundness of an ECU is confirmed on the basis of a combination of information possessed by a plurality of ECUs, vehicle control can be executed soundly even if a security attack related to the vehicle control is received.

### BRIEF DESCRIPTION OF DRAWINGS

FIG. 1 is a block diagram for explaining functions formed in each of a domain ECU and its subordinate ECUs and a connection relationship with parallel domain ECUs and the like in order to explain a configuration of an in-vehicle control system according to Embodiment 1.

FIG. 2 is an overall block diagram for explaining a connection relationship between a plurality of ECUs mounted on a vehicle in order to explain the configuration of the in-vehicle control system according to Embodiment 1.

FIG. 3 is a block diagram for explaining a connection relationship between a central ECU, two of the domain ECUs, and the subordinate ECUs in order to explain the configuration of the in-vehicle control system according to Embodiment 1.

FIG. 4 is a schematic diagram for explaining a program configuration included in an ECU for constructing the in-vehicle control system according to Embodiment 1.

FIG. 5 is a flowchart for explaining operations of the in-vehicle control system according to Embodiment 1.

FIG. 6 is a schematic diagram showing data transmission/reception between the domain ECU and the subordinate ECUs for explaining the configuration of the in-vehicle control system according to Embodiment 1.

FIG. 7 is a diagram in tabular form showing an example of a combination (information set) of a plurality of data used for determining the presence or absence of abnormality and determination results in the in-vehicle control system according to Embodiment 1.

FIG. 8 is a block diagram showing a configuration example of a part for executing arithmetic processing of each ECU constituting the in-vehicle control system according to Embodiment 1.

### MODES FOR CARRYING OUT INVENTION

### Embodiment 1

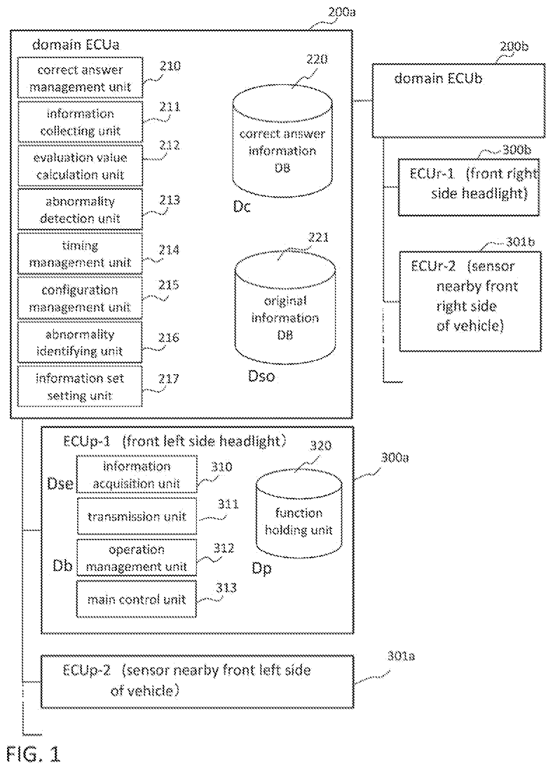

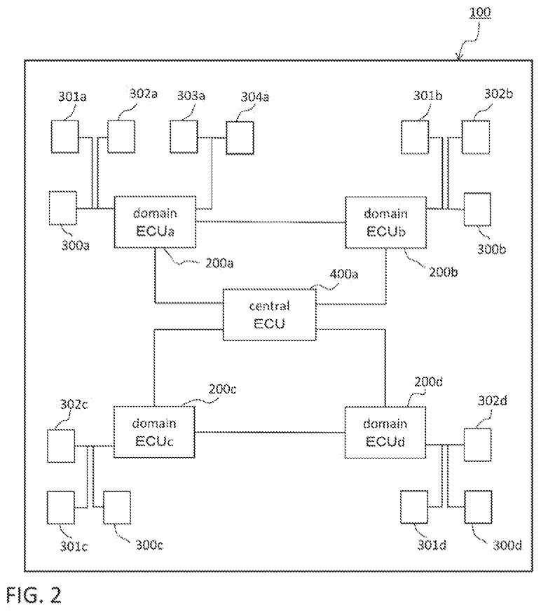

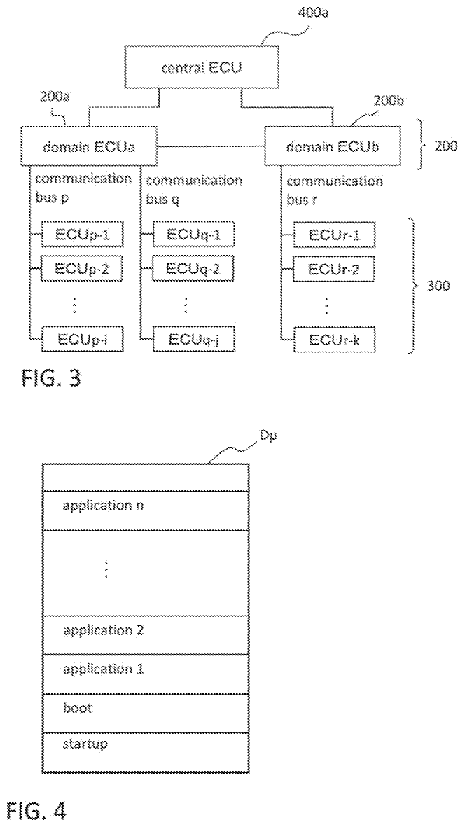

FIG. 1 to FIG. 8 are diagrams for explaining a configuration and operations of an in-vehicle control system according to Embodiment 1, and FIG. 1 is a block diagram for explaining functions formed in a domain ECU as a relay device, functions formed in each of ECUs that is subordinate to the domain ECU and exhibits an individual control function, and a connection relationship of the domain ECU with a parallel domain ECUs in order to explain. the configuration of the in-vehicle control system. Further, FIG. 2 is an overall block diagram for explaining a connection relationship among a plurality of ECUs mounted on a vehicle, FIG. 3 is a block diagram for explaining a connection relationship between two of the domain ECUs connected to a central ECU and their subordinate ECUs by communication buses among a plurality of ECUs, and FIG. 4 is a schematic diagram for explaining a program configuration provided in each of the ECUs.

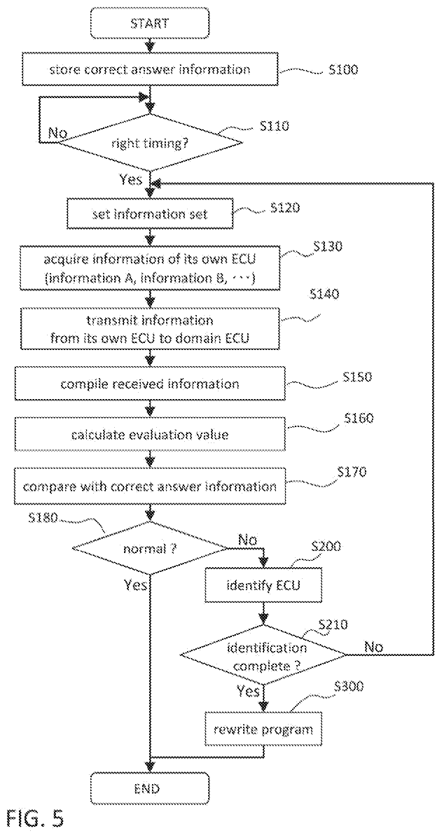

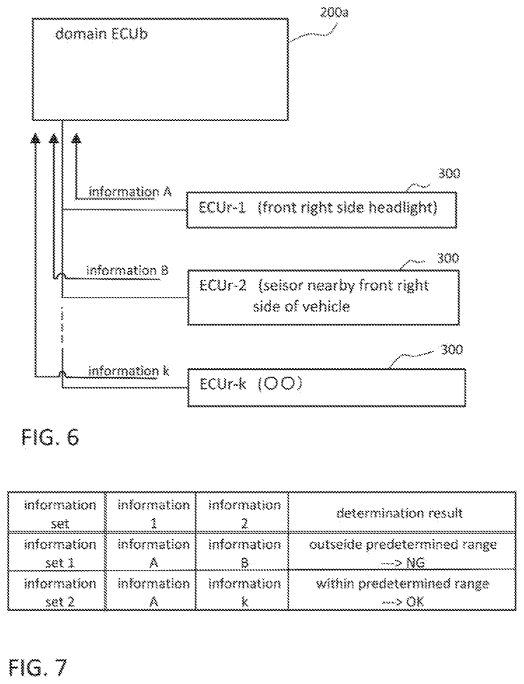

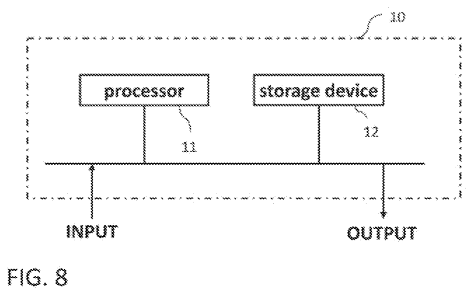

FIG. 5 is a flowchart for explaining operations for the in-vehicle control system, namely, an abnormality diagnosis method. FIG. 6 is a schematic diagram showing transmission/reception of data between the domain ECU and its subordinate ECUs, and FIG. 7 is a diagram in tabular form showing a combination (information set) of a plurality of data set for identifying an abnormal ECU and an example of determination results. Further, FIG. 8 is a block diagram showing an example of a hardware configuration of a part for executing arithmetic processing of each ECU constituting the in-vehicle control system.

As described in the background art, an in-vehicle control system for controlling a vehicle is configured such that each of a plurality of control devices called ECUs is connected to another ECU or a communication device outside the vehicle by wire or wireless. As shown in FIG. 2, the in-vehicle control system according to Embodiment 1 will be described by taking as an example of an in-vehicle control system constituted with a plurality of control devices (ECU) mounted inside a vehicle 100. Note that the in-vehicle control system shown in FIG. 2 actually includes some configurations not shown in the figure, but those that are not related to the explanation of Embodiment 1, especially those that are not directly related to the abnormality diagnosis method, are omitted.

Mounted in the vehicle 100 are a central ECU 400a at the highest level, a domain ECU 200a to a domain ECU 200d as relay devices, and an ECU 300a to an ECU 304a, an ECU 300b to an ECU 302b, an ECU 300c to an ECU 302c, and an ECU 300d to an ECU 302d connected to the domain ECU 200a to the domain ECU 200d. Each ECU is connected from the central ECU 400a in a tree structure, for example, as shown in FIG. 3, the domain ECU 200a is connected to each of an ECUp-1 to an ECUp-i via a communication bus p and each of an ECUq-1 to an ECUq-j via a communication bus q and can communicate with each other.

Further, there is a case where the domain ECU 200a to the domain ECU 200d functioning as relay devices are connected to each other so as to be capable of direct communication without the central ECU 400a intervening therebetween, such. as the domain. ECU 200a and the domain ECU 200b. Note that, although not shown, the vehicle 100 can also communicate with a server located outside the vehicle or another vehicle different from the vehicle 100.

The domain ECU 200a or the domain ECU 200b is an ECU located in any one of the front, rear, left, right, and central regions of the vehicle, and when arranged in the front left of the vehicle, it is connected to ECUs located in the front left of the vehicle. Similarly, the domain ECU 200b is connected to ECUs in a region where it is arranged.

Next, with reference to FIG. 1, vehicle control assigned to each ECU and functions and operations of the components for coping with a security attack will be described by taking the domain ECU 200a and the ECU 300a immediately therebelow as an example. In addition, it is assumed that each of the other domain ECUs: the domain. ECU 200b to the domain ECU 200d, each of the ECU 301a to the ECU 304, the ECU 300b to the ECU 302b, the ECU 300c to the ECU 302c, and the ECU 300d to the ECU 302d have similar functions as those to be described for the domain ECU 200a and the ECU 300a. Therefore, when the domain ECU 200a to the domain ECU 200d are not individually distinguished, they are collectively referred to as a domain ECU 200. Further, if the subordinate ECUs are not individually distinguished, they will be collectively referred to as an ECU 300. Furthermore, when the hierarchical relationship in the tree structure is not distinguished, it is simply referred to as an ECU.

ECU 300a

The ECU 300a includes a function holding unit 320 for holding a program Dp of the latest used for exercising the function assigned to each of the ECUs 300, and a main control unit 313 for exercising the control function to control the vehicle. Further, an operation management unit 312 for managing a processing time or the like when the function is exercised by the program Dp, an information acquisition unit 310 for acquiring individual present information Dse for each ECU 300 related to the configuration of the program Dp, and a transmission unit 311 for transmitting the acquired information to the other ECUs are provided.

On the basis of the program Dp held in the function holding unit 320, the main control unit 313 exercises a function that is necessary for the vehicle control and is assigned to each of their own ECUs 300. For example, when the ECU 300a is an ECU that controls the headlights of a vehicle, the main control unit 313 controls On/Off of the headlights, light distribution, and the like.

The information acquisition unit 310 has a function of acquiring, as individual present information Dse of its own ECU 300, the latest program Dp currently held in the function holding unit 320 or information obtained by processing the latest program Dp. The program Dp may be, for example, the entire configuration of the program Dp as shown in FIG. 4, or any one of the startup, the boot, and an application, or a combination thereof. Further, processed information may be a checksum of the program Dp, a cyclic redundancy check (CRC), a hash, an encrypted value, a message authentication code (MAC), a digital signature, or the like.

The operation management unit 312 has a function of acquiring information (operation information Db) relating to operations in its own ECU, such as processes from a predetermined time tA to tB (>tA) when the program Dp is executed, a process start time, a process time, and a sequence of a plurality of processes. At this time, the state of the vehicle at that time may also be managed in association with the time of the process or process group or the process contents.

The transmission unit 311 has a function of transmitting the individual present information Dse of its own ECU 300 acquired by the information acquisition unit 310 or the operation information Db of its own ECU 300 acquired by the operation management unit 312 to the domain ECU 200a and the other ECUs 300.

Domain ECU 200a

In the domain ECU 200a functioning as the relay device, two databases and eight functional units (correct answer management unit 210 to information set setting unit 217) for controlling the operation timing to evaluate soundness and for executing calculations are formed.

One of the two databases is a correct answer information database 220 that holds correct answer information Dc managed by a correct answer management unit 210 to be described later. The other is an original information database 221 that holds, as original information Dso for restoration, a program Dp or part thereof held by each of the other ECUs 300 at the time of a sound state. Note that, in FIG. 1, “database” is abbreviated as “DB” for simplicity.

The configuration management unit 215 manages, as the original information Dso for the backup, software or part thereof before the other ECUs are mounted in the vehicle, or software or part thereof updated during the operation of the vehicle. Further, a function is provided in which as data necessary for generating the correct answer information Dc to be described later, information indicating the state at the time of a sound state corresponding to each piece of the individual present information Dse and the operation information Db of a plurality of ECUs is also managed, and stored in and read out from the original information database 221.

The information set setting unit 217 sets an information set in which information targeting different ECUs is combined to be used for a soundness evaluation, which is required by the correct answer management unit 210, information collecting unit 211, an abnormality identifying unit 216, and the like that are to be described later.

The correct answer management, unit 210 has a function for managing an expected value (correct answer information Dc) derived from a predetermined calculation formula (basically an evaluation function f to be described later) based on an information set relating to the software configuration or the operation of each of the different ECUs 300 set by the information set setting unit 217. Among the original information Dso managed by the configuration management unit 215, the correct answer information Dc is calculated from software or design specifications before each ECU is mounted in the vehicle or is calculated from software or design specifications updated during the operation of the vehicle. Further, information (for example, initial value or design value) that indicates the state at the time of a sound state and corresponds to the operation information Db may be quantified, and an allowable range may be calculated together. Note that these calculations may be performed within the domain ECU 200a (for example, correct answer management unit 210 itself), or may be performed at a server outside the vehicle and transmitted to the domain ECU 200a. However, basically, the same function as the evaluation function f for calculating an evaluation value Ve to be described later is to be used.

The information collecting unit 211 has functions for collecting and compiling information (individual present information Dse, operation information Db) from the other ECUs (particularly the ECUs 300) and for transmitting the information to an evaluation value calculation unit 212, when the soundness is evaluated.

An abnormality detection unit 213 has a function for determining whether or not the evaluation value Ve calculated by the evaluation value calculation unit 212 to be described later coincides with the correct answer information Dc or is within a predetermined range in order to confirm the soundness.

The evaluation value calculation unit 212 has a function for inputting information received from each of targeted ECUs in combinations selected by the information collecting unit 211 among the combinations set by the information set setting unit 217 into the evaluation function f to calculate the evaluation value Ve as shown in Equation (1). Note that, when the types of information such as the individual present information Dse and the operation information Db are not distinguished, they are simply denoted as “Information A, Information B, . . . ”. Also, when the types of functions to be described later are not distinguished, they are simply denoted as the evaluation function f and the evaluation value Ve,

Ve=f(Information A, Information B, . . . ) (1)

Here, as the evaluation function f, not one type of fixed function but a plurality of types of functions for calculating different types of evaluation values Ve can be set depending on the type of information. For example, assuming that an evaluation function f1 is a function having a value obtained by extracting part of a program that each ECU has or a hash value (individual present information Dse) of the program as an argument, the evaluation function f1 calculates an evaluation value Ve1 for determining whether or not to coincide with the correct answer information Dc.

Further, assuming that an evaluation function f2 is a function having the time of the processing of the ECU 300, the required time, and the sequence of a plurality of processes (operation information Db) as arguments, the evaluation function f2 calculates an evaluation value Ve2 for determining whether or not to fall within the allowable range set for the correct answer information Dc. An example is shown in which the evaluation function f2 is applied to the ECU 300 (for example, ECU 300a or ECU 300b) that controls a headlight so as to automatically change a light distribution amount or an angle depending on a road condition.

There is a system that automatically changes the light distribution of the left and right headlights of a vehicle when the vehicle travels on a curve or when an oncoming vehicle appears, on a road at night. Under normal circumstances, the light distribution of the left and right headlights must be changed at the same timing in accordance with the surrounding conditions, but if the program has been tampered with, the light distribution or the angle at a certain time may not be as designed and the timing may not be synchronized.

Assuming such a case, a combination pattern set by the information set setting unit 217 includes a combination (information set) of the operation information Db related to the control of the headlight in each of the ECU 300a and the ECU 300b. Then, in the domain ECU 200a, the information collecting unit 211 acquires the operation information Db of the headlight mounted on the front left side of the vehicle and the headlight mounted on the front right side of the vehicle from the ECU 300a and ECU 300b. The evaluation value calculation unit 212 selects, as arguments (Information A, Information B, . . . ), a combination of a processing ID, a light distribution amount, an angle, etc. of each of the left and right headlights according to the set information set, and calculates the evaluation value Ve2 using the evaluation function f2. Note that, in addition to the operation information Db from each ECU 300, a measured value or a control value (target value) or the like may be acquired from a control unit (not shown) of the vehicle 100.

Here, the correct answer management unit 210 reads out the correct answer information Dc derived from the operation information Db of the ECU 300a and the ECU 300b that is targeted by Information A, Information B, . . . , etc. stored in the correct answer information database 220. The abnormality detection unit 213 determines whether or not the evaluation value Ve2 calculated by the evaluation value calculation unit 212 is sound by determining whether or not the evaluation value Ve2 falls within a range of the correct answer information Dc that is read out (for example, the range of the time difference in synchronization). Furthermore, by combining the information from the ECUs 300 that control another devices capable of understanding the surrounding conditions, such as a camera or a millimeter wave radar, the validity of the processing of the headlights can be confirmed more accurately.

That is, among the combinations set by the information set setting unit 217, at least for the combinations relating to the operation information Db, combinations of ECUs requiring synchronization or combinations of ECUs related to operation in the vehicle control on the sequence are set. On the other hand, as for the individual present information Dse related to the configuration of the program Dp itself, although it does not necessarily require the relation to the operations, it is desirable to set a combination pattern capable of efficiently identifying an abnormal ECU by the abnormality identifying unit 216 to be described later.

The timing management unit 214 has a function for managing a timing for confirming the soundness by managing the time. For example, when the timing management unit 214 determines that a predetermined timing has come, it may cause the information collecting unit 211 to start collecting information from the ECUs 300 described above.

The abnormality identifying unit 216 selects a plurality of different types of information sets including the ECU 300 included in the information set in which the abnormality has been detected, from among the information sets from a plurality of ECUs 300 set by the information set setting unit 217. Then, on the basis of the comparison result between the evaluation value Ve calculated according to the selected information set and the correct answer information Dc, it has a function for determining to identify which ECU 300 is abnormal.

Referring to the flowchart of FIG. 5, the operations of the in-vehicle control system, namely, the abnormality diagnosis method, constructed by arranging such functions in each ECU 300 that actually controls a vehicle device and in the domain ECU 200, which is the relay device, will be described.

First, the correct answer management unit 210 acquires the correct answer information Dc and stores it in. the correct answer information database 220 (step S100). At this time, as described above, the correct answer information Dc may be calculated by the function corresponding to the evaluation function f using the original information Dso stored in the original information database 221, or may be obtained from the outside of the vehicle 100. When the required correct answer information Dc is limited in the amount, it may be output to the abnormality detection unit 213 in advance.

When the correct answer information Dc is prepared, the timing management unit 214 determines whether or not a predetermined timing is reached. The predetermined timing is selected from a timing at starting, running, stopping, power-off, and the like. When an intended timing is reached (“Yes” in step S110), the processing proceeds to the next step S120 to evaluate the soundness. Otherwise (“No” in step S110), the processing waits until the timing is reached.

In step S120, information set in which information targeting different ECUs is combined from among the correct answer information Dc is set (step S120). In step S130, the information. acquisition unit 310 of each of the ECUs 300 targeted in the set information that is set acquires information (individual present information Dse, operation information Db) of its own ECU 300. In each ECU 300, the transmission unit 311 transmits the information acquired in step S130 to the domain ECU 200a (step S140). When the information is received from each ECU 300, in the domain ECU 200a, the information collecting unit 211 compiles information only used by the evaluation value calculation unit 212 on the basis of the set combination among the received information (step S150).

The evaluation value calculation unit 212 selects an evaluation function f in accordance with the information received from the information collecting unit 211, calculates the evaluation value Ve (step S160), and outputs it to the abnormality detection unit 213. The abnormality detection unit 213 reads out, from the correct answer information database 220, the correct answer information Dc that corresponds to the evaluation value Ye and is output from the evaluation value calculation unit 212, and compares the evaluation value Ve with the correct answer information Dc (step S170).

Then, according to the type of the evaluation value Ve, it is confirmed whether or not the evaluation value Ve coincides with the correct answer information Dc or is within the range indicated by the correct answer information Dc (step S180). If the evaluation value Ve coincides with the correct answer information Dc or is within the range indicated by the correct answer information Dc (“Yes” in step S180), each ECU 300 is determined to be normal and the soundness confirmation flow ends. However, as will be described later, for an information set additionally set at the time of identifying an abnormal ECU, until the identification of the abnormal ECU is completed, and even if the information set is normal, for example, a flag of NC is attached thereto for the processing so as to proceed to step S200.

On the other hand, when the evaluation value Ve does not coincide with the correct answer information Dc or is outside the range indicated by the correct answer information Dc (“No” in step S180), it is determined that an abnormality has occurred within the ECUs 300 targeted by the information set.

If it is determined that an abnormality has occurred, in which ECU 300 the abnormality has occurred is identified (step S200), Specifically, on the basis of the set combination pattern, the processing of the information acquisition unit 310 of targeted ECUs 300 is started again from step S130 with respect to ECUs 300 having an information set different from the information set that is determined to be abnormal at first. Then, the evaluation value calculation unit 212 derives the evaluation value Ve to confirm the coincidence with the correct answer information Dc. By repeating this, it is determined which ECU 300 is abnormal.

For example, among the ECUs 300 as shown in FIG. 6 and FIG. 7, in the case where the combination of Information A from ECUr-1 and Information B from ECUr-2 results in NG at first, and subsequently it is assumed that an evaluation is made using the combination of Information A from ECU-1 and information C from ECUr-k and the result is OK. In this case, since both ECUr-1 and ECUr-k are normal, it can be identified that the abnormality occurs in the remaining ECUr-2. In other words, when n types of ECUs correspond to one information set, the abnormality can be identified by setting the information sets in at least n combinations.

When the identification is completed in this manner (“Yes” in step S210), the configuration management unit 215 reads out a corresponding program for the identified abnormal ECU 300 (here, ECUr-2) from the original information Dso. Then, it is transmitted. to the ECU 300, the program is rewritten (step S300), and the soundness confirmation flow is ended. Note that, at this time, the original information Dso used for the rewriting is, among the data stored in the original information database 221, the software or part thereof before the ECU 300 is mounted in the vehicle and the software or part thereof of the ECU 300 updated during the operation of the vehicle.

By operating as described above, it is possible to determine the soundness of the ECU 300 connected to the domain ECU 200a. Then, even in the event of an abnormality the ECU 300 in which the abnormality has occurred can be identified and the program is rewrote back to the original program, thereby restoring it to the sound state.

Further, since the soundness is evaluated on the basis of the coincidence of the evaluation value Ve calculated by the evaluation function f with the correct answer information Dc calculated for the sound state, the soundness can be confirmed at a lower cost than when the ECU 300 individually confirms the validity of the program or the processes. In particular, in order for each ECU to confirm its own validity, it is generally conceivable that each ECU 300 performs secure boot to confirm that each program has not been tampered with. However, when the secure boot is performed, the startup time increases, and the encryption key for the secure boot must be stored. In contrast, also for the program (individual present information Dse), since the security key is not required by making the evaluation with information sets from the plurality of ECUs as the arguments, it is possible to reduce the cost required therefor.

In general security measures, even when an added ECU is provided with an authorized service, if it is not guaranteed that it is the authorized ECU or that it has the authorized program, it is possible to install an illegal ECU or a program on a vehicle. As a result, it has been difficult to prevent the ECU or the vehicle from being adversely affected (e.g., causing the ECU to be executed improperly). In contrast, according to the in-vehicle control system or the abnormality diagnosis method disclosed in the present application, since the soundness can be evaluated even if there is no guarantee as to whether it is an authorized program or not, these adverse effects can be detected and the normal control of the vehicle can be performed.

In the case where the correct answer information Dc is stored in advance before the domain ECU 200a starts up, the processing from step S120 described in FIG. 5 may be started at the time when the domain ECU 200a starts up. By doing so, immediately after the start of the vehicle (startup of the ECU), more time can be taken to check the functions than during running, so that more ECUs and a wider range of programs can be checked for abnormalities.

Further, in the information set setting process in step S120, an ECU having a function with a long operation period or an ECU that has a special activation condition and is activated only in a specific event may be preferentially selected. For example, there are an ECU for controlling an airbag that is operated only in an emergency, an ECU for controlling a key to be controlled only at the time of the entering into or the leaving from a vehicle, and an ECU for an electronic toll collection (ETC). These ECUs operate infrequently, making it difficult to notice ECU abnormalities. In addition, it is desirable that the function of the ECU to detect a failure of a device and the security function of detecting or responding to a security attack also be selected because they may be the operations only at the time of abnormality or the monitoring period thereof may be long. In this way, it is possible to reliably determine whether or not the ECU that operates infrequency is normal, so that the vehicle can be accurately controlled without impairing convenience.

As shown in FIG. 8, each control device (ECU) constituting the in-vehicle control system according to Embodiment 1 may be configured with one piece of hardware 10 including a processor 11 and a storage device 12. Although not shown, the storage device 12 includes a volatile storage device such as a random access memory and a non-volatile auxiliary storage device such as a flash memory. Further, an auxiliary storage device of a hard disk may be provided instead of the flash memory. The processor 11 executes a program. input from the storage device 12. In this case, the program is input from the auxiliary storage device to the processor 11 via the volatile storage device. Further, the processor 11 may output data such as the calculation result to the volatile storage device of the storage device 12 or may store the data in the auxiliary storage device via the volatile storage device.

Note that, although exemplary embodiments are described in the present application, various features, aspects, and functions described in the embodiments are not inherent in the exemplary embodiments and can be applicable alone or in their various combinations as an embodiment. Accordingly, countless variations that are not illustrated are envisaged within the scope of the art disclosed herein. For example, the case where at least one component is modified, added or omitted, and the case where at least one component is extracted and combined with a component in another embodiment are included.

For example, in the present embodiment, although an example in which each control processing is arranged in the domain ECU 200a is shown, this is not a limitation, and the control processing may be assigned to another domain ECU 200b, a subordinate ECU or the like as long as similar functions can be implemented. Also, the network configuration of the vehicle 100 is not limited to the configuration illustrated in FIG. 1. The number of ECUs and the method for connecting communication lines between ECUs are not limited to this, and information obtained from a plurality of communication lines connected to the domain ECU 200a may be used, or these processes may be executed across a plurality of domain ECUs 200.

As described above, according to the in-vehicle control system of the present application, the in-vehicle control system in which a plurality of control devices (ECU) controlling in-vehicle devices are connected to be able to communicate with each other is configured to include the original information storage unit (original information database 221) for storing the original information Dso related to either a program to implement a control function or operation specifications in the control function when each of the plurality of control devices (ECU) is sound, the information setting unit 217 for setting information set to be used as an argument of a function (evaluation function f) by combining information targeting different control devices (ECU) from among the original information Dso, the information collecting unit 211 for collecting present information. corresponding to the original information Dso as present information (individual present information Dse, operation information Db) from each of the control devices (ECU) targeted in the information set, and the abnormality detection unit 213 for detecting any one of the targeted control devices (ECU) to be abnormal when a degree of coincidence between a correct answer value (correct answer information Dc) calculated by the function (evaluation function f) with the information set as an argument and an evaluation value Ve calculated by the function (evaluation function f) with the present information (individual present information Dse, operation information Db) corresponding to the information set as an argument is lower than a criterion. Therefore, even if a security attack on vehicle control is received, the secure boot is not necessary, and the vehicle control can be performed soundly.

Furthermore, if an abnormality is detected, and when an abnormality identifying unit 216 is provided to cause the information set setting unit 217 to target any one of control devices (ECU) targeted in the set information set and to additionally set an information set that is different from the set information set, and is provided to identify a control device (ECU) with the abnormality from combinations on presence or absence of the abnormality among a plurality of information sets in which the setting is changed, it is possible to easily identify the ECU that has an abnormality.

In this case, the original information storage unit (original information database 221) stores all or part of a program configuration that makes each of the plurality of control devices (ECU) function, and when the configuration management unit 215 is provided to rewrite all or part of a program configuration of a control device (ECU) identified to be abnormal to contents stored in the original information storage unit, the ECU identified to be abnormal can be easily restored to its original normal state.

In a case when the information set is set by combining the information classified into the program (program Dp or part thereof), and when the abnormality detection unit 213 uses the coincidence between the correct answer value (correct answer information Dc) and the evaluation value Ve1 as the criterion, it can easily detect alteration of a program without using the security key.

In a case when the information set setting unit 217 selects control devices (ECU) whose control operations are related to each other (such as synchronization, execution order relation, and similar operations) as the control devices (ECU) to be targeted and sets the information set by combining the information (operation information Db) classified into the operation specifications, and when the abnormality detection unit 213 uses the fact that the evaluation value Ve is within an allowable range set with respect to the correct answer value (correct answer information Dc) as the criterion, it can easily detect alteration or an abnormality of a program without inspecting a program itself.

In particular, when the information set setting unit 217 preferentially selects control device as the control devices to be targeted as the operation period is longer or the activation condition of the operation is more specific (for example, an airbag ECU that operates in an emergency), it can detect an abnormality without leaving out an ECU that is likely to be overlooked.

As described above, according to the abnormality diagnosis method in the embodiment of the present application, the method for diagnosing an abnormality in an in-vehicle control system in which a plurality of control devices (ECU) controlling in-vehicle devices are connected to be able to communicate with each other is configured to include the original information storage step (correct answer information storage step S100) of storing original information Dso related to either a program to implement a control function or operation specifications in the control function when each of the plurality of control devices (ECU) is sound, the information set setting step (step S120) of setting information set to be used as an argument of a function (evaluation function f) by combining information targeting different control devices (ECU) from among the original information Dso, the information collecting step (step S130 to step S150) of collecting present information corresponding to the original information Dso as present information (individual present information Dse, operation information Db) from each of the control devices (ECU) targeted in the information set, and the abnormality detection step (step S160 to step S180) of detecting any one of the targeted control devices (ECU) to be abnormal when the degree of coincidence between the correct answer value (correct answer information Dc) calculated by the function (evaluation function f) with the information set as an argument and an evaluation value Ve calculated by the function (evaluation function f) with the present information (individual present information Dse, operation information Db) corresponding to the information set as an argument is lower than the criterion. Therefore, even if a security attack on vehicle control is received, the secure boot is not necessary, and the abnormality diagnosis can be performed with the vehicle control being performed soundly.

Furthermore, when the abnormality identifying step (step S200 to step S210) is provided in which, when an abnormality is detected, any one of control devices (ECU) targeted in the set information set is targeted, an information set that is different from the set information set is additionally set in the information set setting step (step S120), and a control device (ECU) having the abnormality is identified from combinations on presence or absence of the abnormality among a plurality of information sets in which the setting is changed, an ECU having the abnormality can be easily identified.

in the original information storage step (step S100, or at the time of in-vehicle state, or at the time of new installation), all or part of a program configuration that makes each of the plurality of control devices (ECU) function is stored, and when the configuration management step (step S300) is provided for rewriting all or part of the program configuration of the control device (ECU) identified to be abnormal to the contents stored in the original information storage step, the ECU identified to be abnormal can be easily restored to its original normal state.

### DESCRIPTION OF REFERENCE NUMERALS AND SIGNS

100: vehicle, 200: domain ECU, 210: correct answer management unit, 211: information collecting unit, 212: evaluation. value calculation unit, 213: abnormality detection unit, 214: timing management unit, 215: configuration management unit, 216: abnormality identifying unit, 217: information set setting unit, 220: correct answer information database, 221: original information database (original information storage unit), 300 ECU, 310: information acquisition unit, 311: transmission unit, 312: operation management unit, 313: main control unit, 320: function holding unit, 400a: central ECU, Db: operation information (present information), Dc: correct answer information (correct answer value), Dp: program, Dse: individual present information (present information), Dso: original information, f: evaluation function (function), Ve: evaluation value,

1-6. (canceled)

7. An abnormality diagnosis method in an in-vehicle control system in which a plurality of control devices controlling in-vehicle devices are connected to be able to communicate with each other, the abnormality diagnosis method comprising:
an original information storage step of storing original information related to either a program to implement a control function or operation specifications in the control function when each of the plurality of control devices is sound;
an information set setting step of setting information set to be used as an argument of a function by combining information targeting different control devices from among the original information;
an information collecting step of collecting present information corresponding to the original information as present information from each of the control devices targeted in the information set; and
an abnormality detection step of detecting any one of the targeted control devices to be abnormal when a degree of coincidence between a correct answer value calculated by the function with the information set as an argument and an evaluation value calculated by the function with the present information corresponding to the information set as an argument is lower than a criterion.

8. The abnormality diagnosis method according to claim 7, further comprising an abnormality identifying step in which, when an abnormality is detected, any one of control devices targeted in the set information set is targeted, an information set that is different from the set information set is additionally set in the information set setting step, and a control device having the abnormality is identified from combinations on presence or absence of the abnormality among a plurality of information sets in which the setting is changed.

9. The abnormality diagnosis method according to claim 8, further comprising a configuration management step of rewriting all or part of a program configuration of a control device identified to be abnormal to contents stored in the original information storage step, all or part of a program configuration that makes each of the plurality of control devices function being stored at the original information storage step.

10. An in-vehicle control system in which a plurality of control devices controlling in-vehicle devices are connected to be able to communicate with each other, the in-vehicle control system comprising:
an original information storage circuitry to store original information related to either a program to implement a control function or operation specifications in the control function when each of the plurality of control devices is sound;
an information set setting circuitry to set information set to be used as an argument of a function by combining information targeting different control devices from among the original information;
an information collector to collect present information corresponding to the original information as present information from each of the control devices targeted in the information set; and
an abnormality detector to detect any one of the targeted control devices to be abnormal when a degree of coincidence between a correct answer value calculated by the function with the information set as an argument and an evaluation value calculated by the function with the present information corresponding to the information set as an argument is lower than a criterion.

11. The in-vehicle control system according to claim 10, further comprising an abnormality identifying circuitry to cause, when an abnormality is detected, the information set setting circuitry to target any one of control devices targeted in the set information set and to additionally set an information set that is different from the set information set, and to identify a control device with the abnormality from combinations on presence or absence of the abnormality among a plurality of information sets in which the setting is changed.

12. The in-vehicle control system according to claim 11, further comprising a configuration management circuitry to rewrite all or part of a program configuration of a control device identified to be abnormal to contents stored in the original information storage circuitry, the original information storage circuitry storing all or part of a program configuration that makes each of the plurality of control devices function.

13. The in-vehicle control system of claim 10, wherein the abnormality uses coincidence between the correct answer value and the evaluation value as the criterion in a case when the information set is set by combining the information classified into the program.

14. The in-vehicle control system of claim 11, wherein the abnormality uses coincidence between the correct answer value and the evaluation value as the criterion in a case when the information set is set by combining the information classified into the program.

15. The in-vehicle control system of claim 12, wherein the abnormality uses coincidence between the correct answer value and the evaluation value as the criterion in a case when the information set is set by combining the information classified into the program.

16. The in-vehicle control system of claim 10, wherein the abnormality uses a fact that the evaluation value is within an allowable range set with respect to the correct answer value as the criterion in a case when the information set setting circuitry selects control devices whose control operations are related to each other as the control devices to be targeted and sets the information set by combining the information classified into the operation specifications.

17. The in-vehicle control system of claim 11, wherein the abnormality uses a fact that the evaluation value is within an allowable range set with respect to the correct answer value as the criterion in a case when the information set setting circuitry selects control devices whose control operations are related to each other as the control devices to be targeted and sets the information set by combining the information classified into the operation specifications.

18. The in-vehicle control system of claim 12, wherein the abnormality uses a fact that the evaluation value is within an allowable range set with respect to the correct answer value as the criterion in a case when the information set setting circuitry selects control devices whose control operations are related to each other as the control devices to be targeted and sets the information set by combining the information classified into the operation specifications.

19. The in-vehicle control system of claim 13, wherein the abnormality uses a fact that the evaluation value is within an allowable range set with respect to the correct answer value as the criterion in a case when the information set setting circuitry selects control devices whose control operations are related to each other as the control devices to be targeted and sets the information set by combining the information classified into the operation specifications.

20. The in-vehicle control system of claim 14, wherein the abnormality uses a fact that the evaluation value is within an allowable range set with respect to the correct answer value as the criterion in a case when the information set setting circuitry selects control devices whose control operations are related to each other as the control devices to be targeted and sets the information set by combining the information classified into the operation specifications.

21. The in-vehicle control system of claim 10, wherein the information set setting circuitry preferentially selects control devices as the control devices to be targeted as an operation period is longer or an activation condition of an operation is more specific.

22. The in-vehicle control system of claim 11, wherein the information set setting circuitry preferentially selects control devices as the control devices to be targeted as an operation period is longer or an activation condition of an operation is more specific.

23. The in-vehicle control system of claim 12, wherein the information set setting circuitry preferentially selects control devices as the control devices to be targeted as an operation period is longer or an activation condition of an operation is more specific.

24. The in-vehicle control system of claim 13, wherein the information set setting circuitry preferentially selects control devices as the control devices to be targeted as an operation period is longer or an activation condition of an operation is more specific.

25. The in-vehicle control system of claim 14, wherein the information set setting circuitry preferentially selects control devices as the control devices to be targeted as an operation period is longer or an activation condition of an operation is more specific.

26. The in-vehicle control system of claim 16, wherein the information set setting circuitry preferentially selects control devices as the control devices to be targeted as an operation period is longer or an activation condition of an operation is more specific.
